(19) United States
(12) Patent Application Publication
(10) Pub. No.: US 2007/0271961 A1
(43) Pub. Date: Nov. 29, 2007

(54) Production method and device of optical fiber parent material

(75) Inventors: Dai Inoue, Ibaraki (JP); Makoto Yoshida, Ibaraki (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: SHIN-ETSU CHEMICAL CO., LTD., Tokyo (JP)

(21) Appl. No.: 11/822,992

(22) Filed: Jul. 11, 2007

Related U.S. Application Data
(63) Continuation of application No. PCT/JP05/20601, filed on Nov. 10, 2005.

(30) Foreign Application Priority Data
Jan. 12, 2005 (JP) 2005-005550

(51) Int. Cl. C03B 37/07; C03B 37/018; G01N 21/43

(52) U.S. Cl. 65/377; 65/414; 65/485; 65/484; 65/531

(57) ABSTRACT

A manufacturing method of an optical fiber base material 2 according to a VAD method includes: detecting a tip position of a soot core by means of a discrete value; averaging the value of the detected tip position by a predetermined time; and adjusting a manufacturing condition of the soot core so that the averaged value of the tip position is constant, where in the adjusting step, the manufacturing condition is sequentially adjusted so that a difference between the averaged value of the tip position and a value of a target position set between two adjacent values of the tip position discretely detectable in advance is 0.

### CROSS REFERENCE TO RELATED APPLICATION

This is a continuation application of PCT/JP2005/20601 filed on Nov. 10, 2005 which claims priority from a Japanese Patent Application No. 2005-005550 filed on Jan. 12, 2005, the contents of which are incorporated herein by reference.

### BACKGROUND

1. Technical Field

The present invention relates to manufacturing of an optical fiber base material by means of a VAD method. In particular, the present invention relates to a method and an apparatus for manufacturing an optical fiber base material, which enable stable supply of optical fiber base materials of a high quality.

2. Related Art

One known method of manufacturing an optical fiber base material is a VAD method. For example, in a VAD method, a porous base material that includes a soot core layer and a clad layer is manufactured by depositing glass particles to a tip of a starting material attached to a shaft rising while rotating, where the glass particles have been generated by a soot core deposition burner and a clad deposition burner provided in a process chamber. Thus obtained porous base material is then subjected to dehydration and vitrification into transparent glass, so as to complete an optical fiber base material.

In the stated manufacturing method, it is desirable that the tip position of the soot core is constant throughout the deposition process, for the purpose of stabilizing the characteristics of the resulting optical fiber base material. In view of this, detection of the tip position of the soot core and sequential adjustment of the raising speed and the flow rate of the raw material gas for controlling the tip position constant have usually been performed. It should be noted that in such a case, too, it is still desirable that fluctuations of the raising speed and of the flow rate of the raw material gas are restrained as small as possible.

So as to maintain the tip position of the soot core constant, it is first of all necessary to constantly grasp the tip position with accuracy. Exemplary methods of detecting the tip position include a method of obtaining an image during deposition by means of a camera, and determining the tip position by subjecting the image to image processing, as is disclosed by Japanese Unexamined Patent Application Publication No. S53-87245 and Japanese Unexamined Patent Application Publication No. S60-122736. Here, the resolution in the image processing depends upon the number of scanning lines of the camera. In addition, since the image processing is digital processing with use of a computer and the like, the detected tip position will always be rendered as a discontinuous i.e. discrete value.

In the above-stated detection method, all the tip positions that fall in the range of ±d/2 with respect to the value of the tip position P is detected as the tip position P, where it is assumed that the distance from the value of a tip position P, which is a discrete value, to the adjacent next tip position is d. This poses a problem that when the tip position is being raised or lowered in the range of the distance d, a time lag is incurred till the change in tip position is detected.

Furthermore, when the control amount gets too large compared to the tip position of which the transferal has been detected, the time required to perform re-adjustment gets long. This has resulted in incurring a large speed fluctuation.

### SUMMARY

In view of the above, it is an advantage of the present invention to provide a method and an apparatus for manufacturing an optical fiber base material, which can solve the foregoing problems. The advantage can be achieved by combinations of features described in the independent claims. The dependent claims define further advantageous concrete examples of the present invention.

As a first embodiment of the present invention, provided is a method of manufacturing an optical fiber base material according to a VAD method, including: detecting a tip position of a soot core by means of a discrete value; averaging the value of the detected tip position by a predetermined time; and adjusting a manufacturing condition of the soot core so that the averaged value of the tip position is constant, where in the adjusting step, the manufacturing condition is sequentially adjusted so that a difference between the averaged value of the tip position and a value of a target position set between two adjacent values of the tip position discretely detectable in advance is 0. According to this, during deposition of glass particles, it is possible to maintain the tip position of the soot core constant by detecting the tip position of the soot core constantly with accuracy, and by adjusting the raising speed and/or the flow rate of the raw material to the burner according to the difference from the target position. This contributes to stabilization of the characteristics of an optical fiber base material. This is considered as a result of enabling constant and fine adjustment, by setting the management target value of the soot core tip position between continuous discrete values thereby enabling the tip position to be detected to be either of the two discrete values always at a constant ratio.

As one embodiment, it is possible to arrange so that in the adjusting step of the above-described manufacturing method, the value of the target position may correspond to a dividing point corresponding to 0.4-0.6 relative to a distance between the two adjacent values discretely detectable which is assumed to be 1. According to this, the tip position of a soot core is detected to be either of the two discrete values always at a constant ratio, which enables constant and fine adjustment. Accordingly, although there is a constant minute fluctuation, large fluctuation is prevented eventually by detecting even a slight change in tip position for swift and appropriate adjustment.

When the target position deviates by only a small amount such as about 1/20 of the distance between continuous discrete values, the similar result has been observed. However particularly advantageous results have been obtained when the target position value lies within a range of the dividing point of 0.4-0.6 with respect to two adjacent discrete values. When the tip position falls within this range, the tip position is adjustable by only a small change in speed. Moreover depending on conditions, the tip position is able to be detected as two discrete values respectively, in an appropriate ratio from the fluctuation of an image which is attributable to the rotation of the soot deposition member or to the light of the flame used in deposition. This enables the tip position to be controlled in an extremely narrow range with speed adjustment that is small but non-zero.

Furthermore, as another embodiment, in the manufacturing method, in the adjusting step, the manufacturing condition to be adjusted may be at least one of a) a raising speed of the soot core and b) a flow rate of a raw material gas supplied for the purpose of soot core deposition. According to this, it becomes possible to effectively control the tip position of the soot core by using existing equipment such as a raising speed control apparatus that adjusts the raising speed of the soot core and a mass flow controller that adjusts the flow rate of a raw material gas to be supplied.

As a second embodiment of the present invention, provided is an apparatus for manufacturing an optical fiber base material according to a VAD method, including: a camera that captures an image of a tip position of a soot core; an image processing apparatus that detects the tip position of the soot core by means of a discrete value, by processing the captured image; a controller that averages the discrete value for a predetermined time; and a control adjustment apparatus that sequentially adjusts a manufacturing condition so that a difference between the averaged value of the tip position and a value of a target position set between two adjacent values discretely detectable in advance is 0. According to this, in an apparatus for manufacturing an optical fiber base material, during deposition of glass particles, it is possible to maintain the tip position of the soot core constant by detecting the tip position of the soot core constantly with accuracy, and by adjusting the raising speed and/or the flow rate of the raw material to the burner according to the difference from the target position. This contributes to stabilization of the characteristics of an optical fiber base material.

Furthermore as one embodiment, in the manufacturing apparatus, the control adjustment apparatus may be at least one of a) a raising speed control apparatus that adjusts a raising speed of the soot core and b) a mass flow controller apparatus that controls, via a mass flow controller, a flow rate of a raw material gas to be supplied. According to this, it becomes possible to effectively control the tip position of the soot core by using existing equipment.

### BRIEF DESCRIPTION OF THE DRAWINGS

FIG. 1 is a schematic explanatory diagram showing a control system for a soot core tip position according to a first embodiment example.

FIG. 2 is a schematic explanatory diagram showing a control system for a soot core tip position according to a second embodiment example.

FIG. 3 is a graph showing a control state of a soot core tip position according to the first embodiment example.

FIG. 4 is a graph showing a control state of a soot core tip position according to a first comparison example.

### DESCRIPTION OF EXEMPLARY EMBODIMENTS

As follows, an aspect of the present invention is described by embodiments. The following embodiments do not limit the invention that relates to the claims and not all combinations of the features described in the embodiments are necessarily essential to means for solving the problems of the invention.

### First Embodiment Example

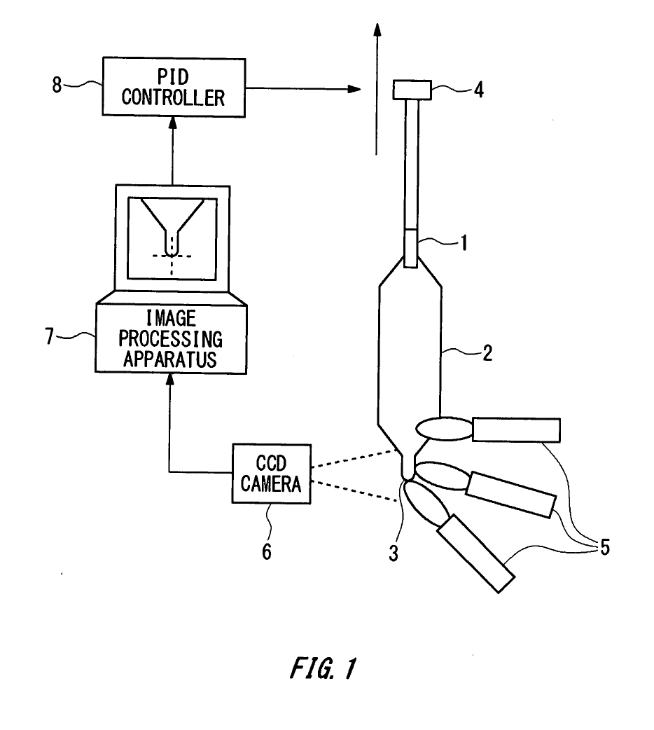

An optical fiber base material 2 was manufactured according to a VAD method by depositing silica particles to a tip of a starting rod 1 being raised while rotating, where the silica particles have been generated by subjecting a raw material gas (e.g. silicon tetrachloride) to flame hydrolysis. During deposition, an image of a tip position 3 of the soot core was captured using a CCD camera 6, thereby detecting the tip position 3 of the soot core from the image by means of an image processing apparatus 7 (see FIG. 1). It should be noted that the detection of the tip position was performed by means of brightness change of the image. Methods of detecting a tip position using brightness change include a method of using a threshold value, a method by means of a change rate of brightness, and so on, which all yield a discrete value that is dependent on the resolution of the image, as the tip position.

A minimum distance of the tip position 3 detectable as a discrete value varies according to the resolution of the image. The system used in the present embodiment example has yielded the minimum distance of 0.2 mm, however. The operation in the system is as follows. This tip position 3 was converted into an analogue electric signal, and input to a PID controller 8. The PID controller 8 performed averaging processing for 20 seconds. Then the raising speed was adjusted by a raising apparatus not shown in the drawings via a hanging mechanism 4, so that the difference between the averaged tip position and the target position is 0. The control during this time is set as PI control which uses a proportional component relative to the difference and an integral component for preventing an offset.

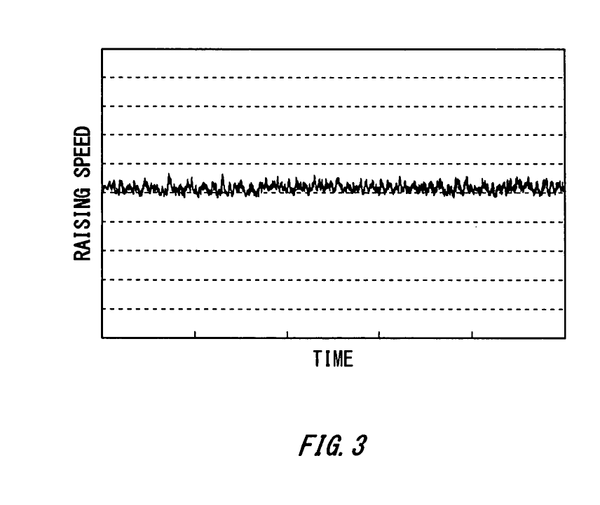

The target position was set as an intermediate value between two adjacent discrete values. As shown in FIG. 3, the tip position and the raising speed did not change largely although having undergone constant and minute fluctuations.

When the target position deviated by only a small amount such as about 1/20 of the distance between two discrete values, for example, the similar result has been observed. However particularly advantageous results have been obtained when the target position lies within a range of the dividing point of 0.4-0.6 with respect to two adjacent discrete values. When the tip position falls within this range, the tip position is adjustable by only a small change in speed. Moreover depending on conditions, the tip position is able to be detected as two discrete values respectively, in an appropriate ratio from the fluctuation of an image which is attributable to the rotation of the soot deposition member or to the light of the flame used in deposition. This enables the tip position to be controlled in an extremely narrow range with speed adjustment that is small but non-zero.

### Second Embodiment Example

An optical fiber base material was manufactured in a system similar to the first embodiment example.

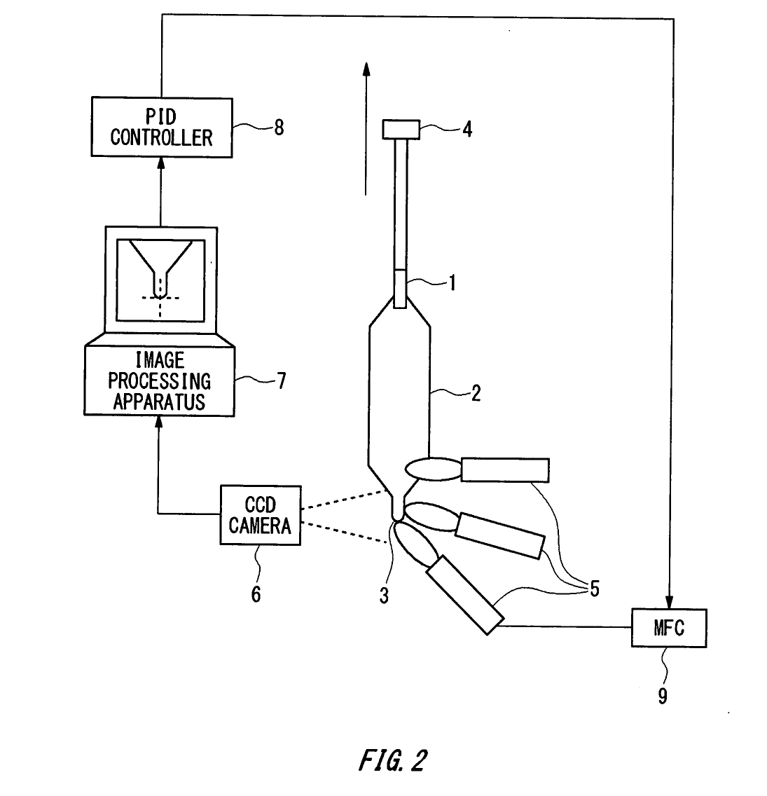

During deposition of silica particles, a tip position 3 of a soot core detected by the CCD camera 6 and the image processing apparatus 7 was converted into an analogue electric signal, and input to the PID controller 8. Then the PID controller 8 performed averaging processing for 20 seconds. Note that the control of the tip position 3 is performed in such a system that the flow rate of the raw material gas to the burner 5 is changed by means of a mass flow controller (flow rate control apparatus) 9 so that the difference between the tip position resulting from the averaging processing and the target position is 0 (See FIG. 2). The control during this time is set as PI control which uses a proportional component relative to the difference and an integral component for preventing an offset.

By setting the target position as an intermediate value between two adjacent discrete values, the tip position and the flow rate of the raw material gas did not change largely although having undergone constant and minute fluctuations, as in the first embodiment example.

When the target position deviated by only a small amount such as about 1/20 of the distance between two discrete values, for example, the similar result has been observed. However particularly advantageous results have been obtained when the tip position lies within a range of the dividing point of 0.4-0.6 with respect to two adjacent discrete values. When the tip position lies in the vicinity thereof, the tip position is adjustable by only a small change in the flow rate of the raw material gas.

### FIRST COMPARISON EXAMPLE

Silica particles were deposited in a system similar to the first embodiment example, while the target position of a soot core tip is substantially equalized to the discrete value.

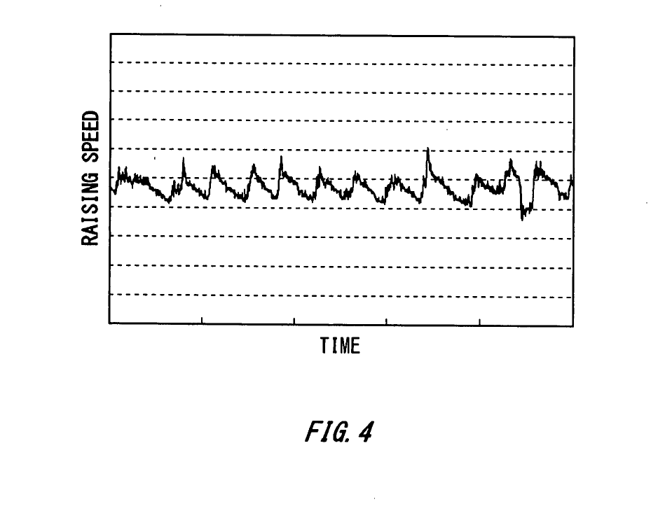

The result was divided between a time period in which the raising speed is substantially constant and a time period in which the raising speed is subjected to large change. In the time period in which the raising speed is substantially constant, the detected tip position matches the target position. Note that in practice, while the tip position is in the range of about 0.2 mm, the tip position is constantly detected to be in the same position. Therefore, for example when the automatically adjusted speed is slightly slower than those required for maintaining the tip position constant, until the tip position changes by 0.2 mm at maximum, the small deviation of the tip position is not to be detected. As a result, sharp change in detected tip position abruptly occurs as can be observed in FIG. 4, which has led to a cause of comparatively large fluctuation in speed.

As described so far, normally the management target for the tip position of the soot core has been set to any of the discretely detected positions. Moreover for this reason, the tip position fluctuates, which has consequently caused fluctuation in raising speed or fluctuation in flow rate of raw material gas in adjusting the position fluctuation. Compared to this, in an aspect of the present invention, by setting the management target of the tip position between the discrete two values, the tip position is detected to be either of the two discrete values always at a constant ratio, which enables constant and fine adjustment. Accordingly, although there is a constant minute fluctuation, large fluctuation is prevented eventually by detecting even a slight change in tip position for swift and appropriate adjustment.

While an aspect of the present invention has been described by way of the above-described embodiment, the technical scope of the invention is not limited to the above described embodiment. It is apparent to persons skilled in the art that various alternations and improvements can be added to the above-described embodiment. It is apparent from the scope of the claims that the embodiment added such alternation or improvements can be included in the technical scope of the invention.

As apparent from the foregoing description, according to one embodiment of the present invention, during deposition of glass particles, it is possible to maintain the tip position of the soot core constant by detecting the tip position of the soot core constantly with accuracy, and by adjusting the raising speed and/or the flow rate of the raw material to the burner according to the difference from the target position. This contributes to stabilization of the characteristics of an optical fiber base material.

What is claimed is:

1. A method of manufacturing an optical fiber base material according to a VAD method, comprising:
detecting a tip position of a soot core by means of a discrete value;
averaging the value of the detected tip position by a predetermined time; and
adjusting a manufacturing condition of the soot core so that the averaged value of the tip position is constant, wherein
in the adjusting step, the manufacturing condition is sequentially adjusted so that a difference between the averaged value of the tip position and a value of a target position set between two adjacent values of the tip position discretely detectable in advance is 0.

2. The manufacturing method as set forth in claim 1, wherein
in the adjusting step, the value of the target position corresponds to a dividing point corresponding to 0.4-0.6 relative to a distance between the two adjacent values discretely detectable which is assumed to be 1.

3. The manufacturing method as set forth in claim 1, wherein
in the adjusting step, the manufacturing condition to be adjusted is a raising speed of the soot core.

4. The manufacturing method as set forth in claim 1, wherein
in the adjusting step, the manufacturing condition to be adjusted is a flow rate of a raw material gas supplied for soot core deposition.

5. An apparatus for manufacturing an optical fiber base material according to a VAD method, comprising:
a camera that captures an image of a tip position of a soot core;
an image processing apparatus that detects the tip position of the soot core by means of a discrete value, by processing the captured image;
a controller that averages the discrete value for a predetermined time; and
a control adjustment apparatus that sequentially adjusts a manufacturing condition so that a difference between the averaged value of the tip position and a value of a target position set between two adjacent values discretely detectable in advance is 0.

6. The manufacturing apparatus as set forth in claim 5, wherein
the control adjustment apparatus is a raising speed control apparatus that adjusts a raising speed of the soot core.

7. The manufacturing apparatus as set forth in claim 5, wherein
the control adjustment apparatus is a mass flow controller apparatus that controls, via a mass flow controller, a flow rate of a raw material gas to be supplied.

8. The manufacturing apparatus as set forth in claim 5, wherein
the camera is a CCD camera.

9. The manufacturing apparatus as set forth in claim 5, wherein
the image processing is digital processing, and the controller performs the averaging, after converting the discrete value into an analogue signal.

10. The manufacturing apparatus as set forth in claim 9, wherein
the controller is a PID controller.

11. The manufacturing apparatus as set forth in claim 5, wherein
the detection of the tip position is performed by means of brightness change of the image.

12. The manufacturing apparatus as set forth in claim 5, wherein
a minimum distance of the tip position detectable as the discrete value is 0.2 mm.
